(19) United States
(12) Patent Application Publication
(10) Pub. No.: US 2006/0068887 A1
(43) Pub. Date: Mar. 30, 2006

(54) Transparent gaming objects in a video wagering game

(76) Inventors: David Michael Pryor, Westmont, IL (US); Robert Karl Ekl, Skokie, IL (US)

Correspondence Address: Schwegman, Lundberg, Woessner & Kluth, P.A., P.O. Box 2938, Minneapolis, MN, 55402, US

(21) Appl. No.: 11/225,854

(22) Filed: Sep. 13, 2005

Related U.S. Application Data
(60) Provisional application No. 60/609,479, filed on Sep. 13, 2004.

(51) Int. Cl. A63F 13/00

(52) U.S. Cl. 463/20

(57) ABSTRACT

A computerized wagering game system has a gaming module comprising a processor and gaming code which is operable when executed on the processor to conduct a wagering game on which monetary value can be wagered. A video module is operable to display one or more gaming objects, and a background image. The one or more gaming objects have a degree of transparency so that the background image can be seen through the one or more gaming objects.

### RELATED APPLICATION

This application claims priority under 35 U.S.C. 119(e) from U.S. Provisional Application Ser. No. 60/609,479, filed 13 Sep. 2004, which application is incorporated herein by reference.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### FIELD OF THE INVENTION

The invention relates generally to wagering gaming systems, and more specifically to a video reel slot machine game having transparent gaming objects.

### BACKGROUND OF THE INVENTION

A wide variety of gaming devices are now available to gamers and to casino operators in computerized form, from slot machines to games that are traditionally played live such as poker and blackjack. These computerized games provide many benefits to the game owner and to the gambler, including greater reliability than can be achieved with a mechanical game or human dealer, more variety, sound, and animation in presentation of a game, and a lower overall cost of production and management.

Computerized video game systems must be designed with many of the same concerns as their mechanical and table game ancestors—they must be fair, they must provide sufficient feedback to the gamer to make the game fun to play, and they must meet a variety of gaming regulations to ensure that both the machine owner and gamer are honest and fairly treated in implementing the game. Further, they must provide a gaming experience that is at least as attractive as the older mechanical gaming machine experience to the gamer, to ensure success in a competitive gaming market.

Many computerized wagering game systems have a variety of graphical elements, including thematic elements such as background images, cartoon-like characters, and animations designed to attract and keep a game player's attention. The games often have a specific theme, such as a fishing theme or an exotic location adventure theme designed to attract the attention of those having a general interest in such a theme, or have a specific brand identity, such as a Monopoly(tm)-themed game employing elements of the familiar Parker Brothers(tm) board game of the same name. The game player's interest in the theme of the game makes the game more attractive to the game player and may hold the game player's interest longer, resulting in a more profitable gaming machine for the gaming establishment and game manufacturer.

But, traditional wagering games have many elements central to game play that game players also expect to see prominently displayed, and with which they are familiar. Cards displayed in an orderly fashion for card games, dice are displayed prominently in dice games, and slot machine reels are clearly displayed for electronic video slot machines. While these elements are necessary parts of the game and are key to the outcome of the game, presentation of these elements can interfere with presentation of the game's chosen theme. Some incorporation of thematic elements has be made, such as creating theme-based symbols for display on a reel slot machine, but it remains desirable to achieve greater incorporation of thematic elements into the wagering game presented to the game player.

### SUMMARY OF THE INVENTION

The present invention provides in one embodiment a computerized wagering game system has a gaming module comprising a processor and gaming code which is operable when executed on the processor to conduct a wagering game on which monetary value can be wagered. A video module is operable to display one or more gaming objects, and a background image. The one or more gaming objects have a degree of transparency so that the background image can be seen through the one or more gaming objects.

### BRIEF DESCRIPTION OF THE FIGURES

FIG. 1 shows a computerized reel slot gaming system, consistent with an example embodiment of the invention.

FIG. 2 shows a computerized reel slot machine screen having transparent reel objects, consistent with an embodiment of the present invention.

FIG. 3 shows a computerized playing card game screen having transparent playing cards, consistent with an embodiment of the present invention.

FIG. 4 shows a computerized dice game having transparent dice, consistent with an embodiment of the present invention.

FIG. 5 is a flowchart showing an example method of practicing the present invention.

### DETAILED DESCRIPTION

In the following detailed description of sample embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the spirit or scope of the present invention. The following detailed description is, therefore, not to be taken in a limiting sense, and the scope of the invention is defined only by the appended claims.

The present invention provides in one embodiment a computerized wagering game system has a gaming module comprising a processor and gaming code which is operable when executed on the processor to conduct a wagering game on which monetary value can be wagered. A video module is operable to display one or more gaming objects, and a background image. The one or more gaming objects have a degree of transparency so that the background image can be seen through the one or more gaming objects.

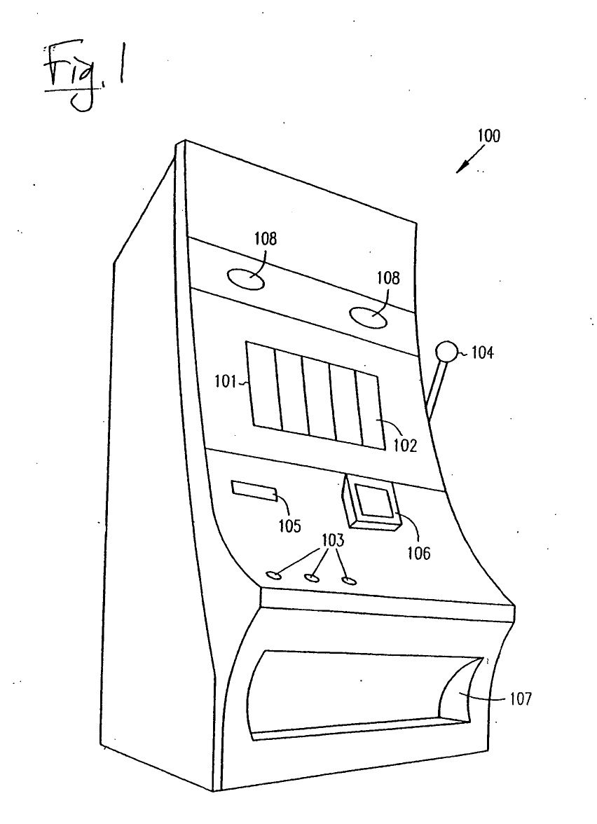

FIG. 1 illustrates a computerized wagering game machine, as may be used in an embodiment of the present invention. The computerized gaming system shown generally at 100 is a video gaming system, which displays information for at least one wagering game upon which monetary value can be wagered on video display 101. Alternate embodiments of the invention will have other game indicators, such as mechanical reels instead of the video graphics reels 102. The game of chance is played and controlled with various buttons 103, and in some embodiments also with a pull arm 104 to initiate reel spin. Value is wagered on the games, such as with tokens, coins, bills, or cards that hold value. The wagered value is conveyed to the machine through a changer 105 or a secure user identification module interface 106, and winnings are returned via the returned value card or through the coin tray 107. Sound is also provided through speakers 108.

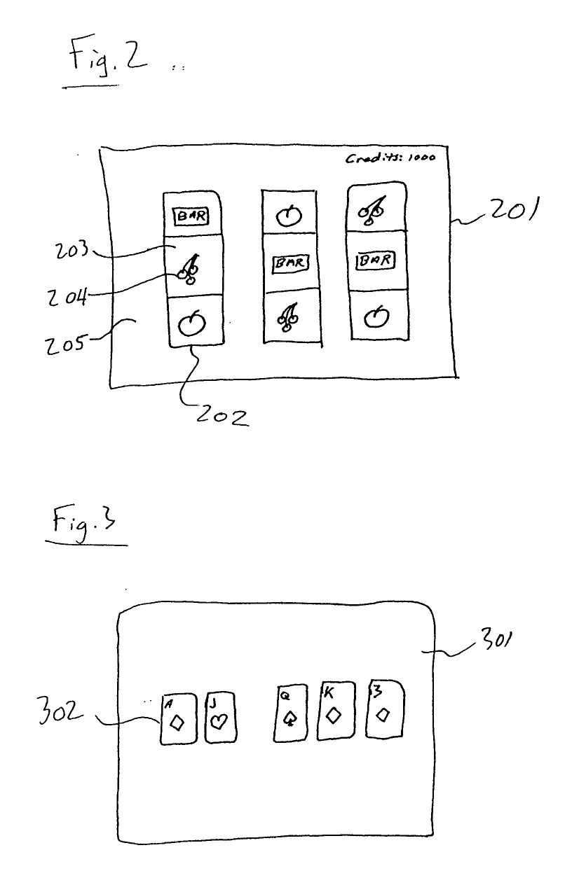

FIG. 2 illustrates an example reel slot computerized wagering game screen having transparent gaming objects. The image displayed on the wagering game system's display 101 is shown generally at 201, and includes three slot machine reels as shown at 202. Other examples include a different number of reels, such as five slot machine reels, and feature gaming objects other than reels. Each reel shown in FIG. 2 includes several reel objects, such as the reel background 203 and the cherry object 204. The video display further includes a background scene or image at 205.

In various examples, one or more components of the gaming objects will be transparent. For example, the reel background color or image shown at 203 that defines the size of the reel will be transparent in one example, while the cherry object 204 will not. This will enable the game player to clearly see the gaming object 204, while being able to see the background image 205 through the reel 203. Both the reel and the objects on the reel are gaming objects, and various combinations of transparency are employed in various embodiments of wagering game machines.

In another example, both the reel 203 and the gaming objects 204 are transparent. A background image 205 is visible through reel background color 203 and through the various reel objects 204 after a reel spin because the reel objects 204 and reel background colors 203 are transparent, while any reel objects 204 used to form a winning line in the reel slot machine game are shown opaque after the reels have completed their spin. The win line of objects is therefore clearly visible to the game player, while reel objects not involved in a win line are displayed with some transparency.

In other embodiments, transparency is used to indicate a change in the state of the reel slot machine game, such as entry of a bonus round. Gaming regulations require visible indicators of changes in odds, so transparency is used in one example to demonstrate that a bonus round having different odds than a regular reel slot machine round is underway.

The reel background color shown at 203 in this example is a solid color that blends into the reel background color rendered with the objects above or below reel object 204, resulting in the appearance of a continuous reel. By only rendering reel objects and their background colors in a defined reel space using a process known as clipping, the appearance of a continuous reel is created. The reel object 204 is in some examples a part of the same image or object as the background color 203, while in other examples the reel object 204 is rendered on top of the background color 203. In cases where the reel object 204 is rendered as a separate object, the reel background 203 can be a single, continuous background object for the whole reel, and only the reel objects 204 need move or be clipped at the top and bottom of the rendered reel.

The technology employed to render transparent objects in one example utilizes what are known in the art as alpha channels and z-channels in rendering various screen images. Alpha channels are can be thought of in one embodiment as a layer of an image, or a set of data having a stored value for each pixel location of an image. The stored values or layer data are numbers within a predetermined range that specify how opaque or transparent the particular associated image is to be rendered. For example, an alpha channel storing 8 bits (binary digits) per pixel can have one of 256 values, which represent a corresponding pixel's being completely transparent, completely opaque, or one of 254 incremental steps between.

When a pixel in an image or object has a degree of transparency, part of any background image located behind the image can be seen through the pixel. This occurs in a process known as compsiting in the computer graphics field, which means making a video graphic image out of one or more distinct images or objects. Drawing the resulting images is also more broadly known as rendering, which means simply drawing an image from the image data provided. In order to properly composite or render the image, it must be known what objects are in front of what other objects, whether transparent or opaque. This is managed by use of z-channels, which define the depth of each rendered or composited object. Z-buffers are also used in rendering three-dimensional objects, to determine what pixels are nearest to the viewer and what pixels are concealed or hidden by nearer picture objects.

For example, a z-channel may use a 16-bit value for each pixel of an image or object to define the depth of the image. Using signed 16-bit values, a value of −32,768 is farthest away from the viewer, while a value of 32,767 is the nearest to the viewer. Simple compositing of a few images that do not vary in depth will not require so many intermediate values in a z-buffer and may work with fewer bits, but most modern video graphics hardware is designed to render three dimensional objects and already supports very high resolution z-buffers. In the example of FIG. 2, a static background image 205 has a z-buffer value of 0, or of any value less than the z-buffer value of the reel objects 203 and 204. In a more complex example, the background features three-dimensional animation, and uses z-buffer values from −32,768 to 0, or half of the available values, to render the three-dimensional objects. The foreground images, including the reel objects 203 and 204, as well as text such as a credit counter, are rendered over the background image by assigning z-buffer values greater than 0. In this way, reel background 203 and reel objects 204 can be rendered on top of even a complex three-dimensional background image 205, and can include alpha channel transparency information making the background information visible to some degree through the front objects.

FIG. 3 shows an example in which playing cards are made transparent. If the five cards shown on the screen at 301 are from a five card stud game in which the player has four cards shown face up and one card shown face down, the face down card 302 can be distinguished from the other cards by overlaying the card with a semi-transparent image of the back of the card, making the card appear to be face down but transparent. In a further example, the face image of the down card is flipped horizontally, making the illusion of being able to see through a transparent card flipped face down even ore convincing.

Transparent cards will also be well-suited to a variety of other games in which the game player has the right to see his or other players' cards that are face down. Hold 'em poker games in which each player has face down cards can be presented such that the game player's face down cards are transparent. In another example, when a player other than the active game player (such as a computerized opponent) folds, the face-up cards of the folded hand remain visible to the game player by becoming transparent.

Cards having see-through properties are used in other wagering games in further examples, such as in blackjack. In blackjack, a player is initially dealt a face down card and then is dealt one or more face up cards to complete a blackjack hand. The face down card is identified in one example by having the face of the card flipped horizontally or vertically and by having a transparent image of the back of the card rendered over the face of the card. Further, even face-up cards are transparent in some embodiments, such as to show which cards were not used to make a winning hand, or simply to enable the game player to see a background image rendered behind the cards.

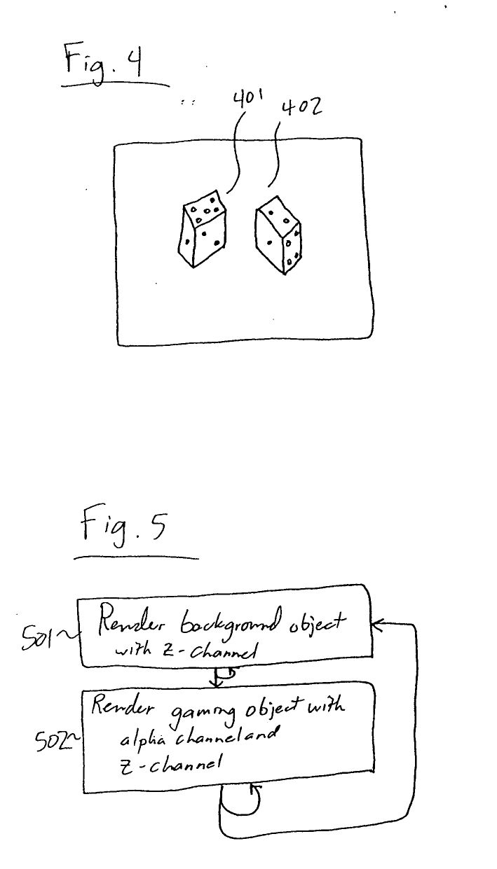

FIG. 4 shows an example in which dice are the transparent gaming object. Traditional casino dice are made of a cube of transparent red plastic having white plastic plugs embedded in the faces to indicate the number resulting from a roll of the dice. In contrast, most home game dice are of a solid color, and have painted dots or paint in shallow dimples to indicate the number resulting from a roll. Because one of the unique experiences in playing casino dice games is using casino dice, it is desirable to carry the transparent characteristics of casino dice over into video games involving dice by making the dice bodies transparent. In FIG. 4, die 401 and die 402 are therefore in one example rendered in three dimensions, using transparent red dice bodies and opaque white material plugs to indicate the numbers. The game player can then not only see through the dice to see the white plastic number plugs on back sides of the dice, but can also see a game table or other background image through the dice.

FIG. 5 shows a flowchart of a rendering or compositing process as is used in some examples to create a background and a transparent gaming object. The background is first rendered at 501. The background includes z-channel information indicating the relative depth of the background images, so that the intended foreground objects can be rendered in front of the background images. Next, either the background is altered by rendering a new background image, or the transparent wagering game object is rendered at 502. The transparent wagering game object is rendered with a z-channel indicating its position in front relative to the background image, and is rendered with an alpha channel that defines it transparency. After 502, the transparent wagering game object may be rendered again, or the background image may be updated.

In practice, this flowchart illustrates that in some cases the background image may be static while the transparent gaming object moves or changes in other ways. In other cases, the background changes while the transparent gaming object remains the same, or both the background and the transparent gaming object change. The changes in various objects are made via a rendering engine or module, which is embodied in hardware, software, or some combination thereof. This illustrates one way that a composited image displayed on the wagering game machine's display image can be formed and altered by changing only certain objects on the screen, such as by changing the background, the transparent game objects, or both.

These are but examples of ways in which transparent game objects can enhance a wagering game experience by making more visible to the game player. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the full scope of equivalents thereof.

1. A computerized wagering game system, comprising:
a gaming module comprising a processor and gaming code which is operable when executed on the processor to conduct a wagering game on which monetary value can be wagered;
a video module operable to display one or more gaming objects and a background image, the one or more gaming objects having a degree of transparency so that the background image can be seen through the one or more gaming objects.

2. The computerized wagering game system of claim 1, wherein the one or more gaming objects are video slot machine reels.

3. The computerized wagering game system of claim 1, wherein the one or more gaming objects are playing cards.

4. The computerized wagering game system of claim 1, wherein the one or more gaming objects are dice.

5. The computerized wagering game system of claim 1, wherein the degree of transparency of the one or more gaming objects indicates a state of the one or more gaming objects.

6. The computerized wagering game system of claim 1, wherein the one or more gaming objects comprise reel symbols, and the transparency of the one or more reel symbols indicate inclusion or exclusion in a win line.

7. The computerized wagering game system of game 1, wherein the one or more gaming objects comprise playing cards, and transparency of one or more of the playing cards indicate that the transparent card is a down card.

8. The computerized wagering game of claim 1, wherein transparency of the one or more gaming objects indicate a bonus condition.

9. A method of operating a computerized wagering game machine, comprising:
conducting a wagering game on which monetary value can be wagered by executing gaming code on a processor within a gaming module;
displaying one or more gaming objects and a background image, the one or more gaming objects having a degree of transparency so that the background image can be seen through the one or more gaming objects.

10. The method of claim 9, wherein the one or more gaming objects are video slot machine reels.

11. The method of claim 9, wherein the one or more gaming objects are playing cards.

12. The method of claim 9, wherein the one or more gaming objects are dice.

13. The method of claim 9, wherein the degree of transparency of the one or more gaming objects indicates a state of the one or more gaming objects.

14. The method of claim 9, wherein the one or more gaming objects comprise reel symbols, and the transparency of the one or more reel symbols indicate inclusion or exclusion in a win line.

15. The method of game 9, wherein the one or more gaming objects comprise playing cards, and transparency of one or more of the playing cards indicate that the transparent card is a down card.

16. The method of claim 9, wherein transparency of the one or more gaming objects indicate a bonus condition.

17. A machine-readable medium with instructions stored thereon, the instructions when executed operable to cause a computerized wagering game system to:
conducting a wagering game on which monetary value can be wagered by executing gaming code on a processor within a gaming module;
displaying one or more gaming objects and a background image, the one or more gaming objects having a degree of transparency so that the background image can be seen through the one or more gaming objects.

18. The machine-readable medium of claim 17, wherein the one or more gaming objects are video slot machine reels.

19. The machine-readable medium of claim 17, wherein the one or more gaming objects are playing cards.

20. The machine-readable medium of claim 17, wherein the one or more gaming objects are dice.

21. The machine-readable medium of claim 17, wherein the degree of transparency of the one or more gaming objects indicates a state of the one or more gaming objects.

22. The machine-readable medium of claim 17, wherein the one or more gaming objects comprise reel symbols, and the transparency of the one or more reel symbols indicate inclusion or exclusion in a win line.

23. The machine-readable medium of game 17, wherein the one or more gaming objects comprise playing cards, and transparency of one or more of the playing cards indicate that the transparent card is a down card.

24. The machine-readable medium of claim 17, wherein transparency of the one or more gaming objects indicate a bonus condition.

25. A computerized wagering game system, comprising:
a gaming module comprising a processor and gaming code which is operable when executed on the processor to conduct a wagering game on which monetary value can be wagered;
a video module operable to display one or more slot machine reels and a background image, the one or more slot machine reels having a degree of transparency so that the background image can be seen through the one or more reels.

26. The computerized wagering game system of claim 25, wherein the one or more slot machine reels include a plurality of reel symbols, and wherein the one or more of the reel symbols are further transparent.

27. The computerized wagering game system of claim 25, wherein the one or more slot machine reels include a plurality of reel symbols, and wherein one or more of the reel symbols are not transparent.

28. The computerized wagering game system of claim 25, wherein the background comprises animation that is visible through the one or more transparent slot machine reels.

29. The computerized wagering game system of claim 25, wherein alpha channel information comprising a part of the one or more transparent slot machine reels defines the degree of transparency of the one or more transparent slot machine reels.

30. A computerized wagering game system, comprising:
a gaming module comprising a processor and gaming code which is operable when executed on the processor to conduct a wagering game on which monetary value can be wagered;
a video module operable to display one or more dice, the one or more dice having a body having a degree of transparency so that the dice sides not facing the game player can be observed through the dice.

31. The computerized wagering game system of claim 30, wherein the one or more dice further comprise opaque inserts indicating the number value of one or more faces of the dice.

32. A computerized wagering game system, comprising:
a gaming module comprising a processor and gaming code which is operable when executed on the processor to conduct a wagering game on which monetary value can be wagered;
a video module operable to display one or more playing card gaming objects and a background image, at least of the one or more playing card gaming objects having a degree of transparency so that the background image can be seen through the one or more playing card gaming objects.
